(19) United States
(12) Patent Application Publication
(10) Pub. No.: US 2013/0191519 A1
(43) Pub. Date: Jul. 25, 2013

(54) Component Placement for Application-Level Latency Requirements

(71) Applicants: Fangzhe Chang, Edison, NJ (US); Ramesh Viswanathan, Manalapan, NJ (US); Thomas L. Wood, Colts Neck, NJ (US)

(72) Inventors: Fangzhe Chang, Edison, NJ (US); Ramesh Viswanathan, Manalapan, NJ (US); Thomas L. Wood, Colts Neck, NJ (US)

(73) Assignee: ALCATEL-LUCENT USA INC., Murray Hill, NJ (US)

(21) Appl. No.: 13/354,435

(22) Filed: Jan. 20, 2012

(51) Int. Cl. G06F 15/173

(52) U.S. Cl. 709/223

(57) ABSTRACT

Methods, systems, and apparatuses for component placement based on application-level latency requirements are provided. Component placement includes receiving a request for a location assignment of an application component or for location assignment of multiple application components within a cloud computing platform. A set of potential location assignments is determined for the application component within the cloud computing platform. A mapping is iteratively determined based on the set of potential location assignments and a latency performance threshold, and a location assignment is selected for the application component based on the mapping.

### TECHNICAL FIELD

This specification relates generally to applications hosted on cloud computing platforms, and more particularly to methods for determining location assignments for application components.

### BACKGROUND

CPU and device virtualization technology allows applications to be hosted on cloud computing platforms, which can result in lower implementation costs and greater elasticity and reliability. Certain components of a cloud-hosted application may reside in the cloud (e.g., in data centers), while others, such as a component tied to a physical device, may be located outside of the cloud.

Latency for a cloud-hosted application is typically defined as the total amount of processing time and communication time necessary to complete an application procedure, and for practical purposes many application procedures have latency performance requirements. Mobile telecommunications services applications, in particular, have stringent latency performance requirements for interactions between user equipment devices (e.g., handsets) and network components located in the cloud. While processing time for a component is independent of its location, communication time varies based on the physical locations of interacting components that are both within and outside the cloud. As such the placement of network components is known to affect latency performance.

### SUMMARY

A method for determining a location assignment for an application component within a cloud computing platform is presented. The method is capable of placing an application component within a cloud computing platform to implement a cloud-hosted application procedure (e.g., a telecommunications service), wherein the placement contributes to meeting specified latency performance requirements and generally provides an improvement in latency performance over a random placement.

In accordance with an embodiment, a method for determining a location assignment for an application component is provided. A request is received for a location assignment of an application component within a cloud computing platform. A set of potential location assignments is determined for an application component within a cloud computing platform. A mapping is iteratively determined based on the set of potential location assignments and a latency performance threshold, and a location assignment is selected for the application component based on the mapping.

In accordance with an embodiment, the set of potential location assignments is determined based on an application procedure or user equipment device associated with the application component, the mapping is iteratively determined based on a triangular inequality of network delay property, and the set of potential locations within the cloud computing platform comprise cloud-hosted data centers.

In accordance with an embodiment, the set of potential location assignments is determined for the application component based on secondary criteria such as a location assignment for an associated backup application component or an application component capacity threshold for a potential location.

In accordance with an embodiment, the cloud computing platform may comprise a plurality of application components and one or more determined location assignments may be associated with one or more of the plurality of application components, wherein a ranking order may be determined for the plurality of application components based on the one or more determined location assignments. An application component may be selected based on the ranking order and the set of potential location assignments may be determined for the application component based on the one or more determined location assignments.

These and other advantages of the present disclosure will be apparent to those of ordinary skill in the art by reference to the following detailed description and the accompanying drawings.

### BRIEF DESCRIPTION OF THE DRAWINGS

FIG. 1 is a diagram of a cloud computing platform in accordance with an embodiment;

FIG. 2 is a diagram of a telecommunications network in accordance with an embodiment;

FIG. 3 illustrates a location assignment algorithm for determining an optimal placement of an application component within a cloud computing platform in accordance with an embodiment;

FIG. 4 illustrates a location assignment algorithm for determining a near-optimal placement of an application component within a cloud computing platform in accordance with an embodiment;

FIG. 5A is a flowchart of a process for determining a location assignment for an application component within a cloud computing platform in accordance with an embodiment;

FIG. 5B is a flowchart of a process for determining a location assignment for an application component within a cloud computing platform in accordance with another embodiment;

FIG. 6 is a high-level block diagram of an exemplary computer that may be used for determining a location assignment for an application component within a cloud computing platform.

### DETAILED DESCRIPTION

Methods for determining a location assignment for an application component within a cloud computing platform are disclosed. In particular, the embodiments disclose an approach for partitioning a placement problem into smaller sub-problems that can be solved more efficiently.

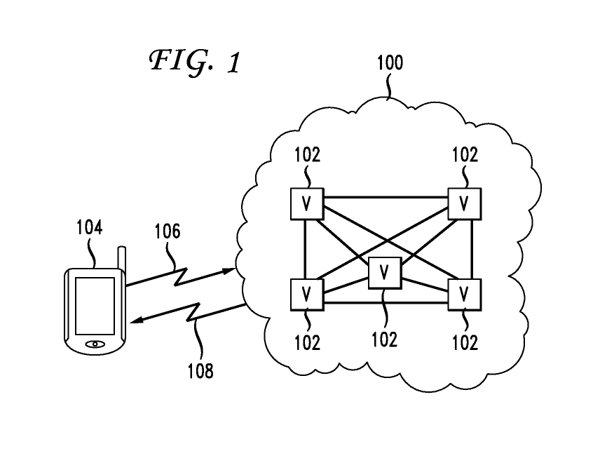

FIG. 1 is a diagram of a cloud computing platform in accordance with an embodiment. Cloud computing platform 100 includes one or more interconnected data centers 102. For example, the interconnected data centers 102 can include both public cloud data centers and private enterprise data centers, or other locations where cloud-hosted application components can reside. As such, cloud computing platform 100 can be represented by a mathematical expression, (V, w), where a set of interconnected data centers, V, have a network delay for performing cloud-hosted application procedures (i.e., a latency due to processing time, transmission time between data centers, etc.) defined by the function, w: V×V→R₊. The network delay function, w, is defined for all pairs in V×V, with the following properties:
1) (undirected) for any v₁, v₂ in V, w(v₁, v₂)=w(v₂, v₁)
2) (triangular inequality) for any v₁, v₂, v₃ in V, w(v₁, v₃)≦w(v₁, v₂)+w(v₂, v₃)
3) (smaller intra-data center delay) for any v₁, v₂, v₃ in V, v₂≠v₃→w(v₁, v₁)≦w(v₂, v₃)

The latency (turnaround time) of an application procedure includes both application component processing time and communication time between application components. Application-level latency performance requirements specify the bounds of turnaround time for a cloud-hosted application procedure. In a cloud-based telecommunications network, an application procedure often begins with a user equipment device (UE) 104 transmitting a request 106 to cloud 100, and involves a collaboration between a plurality of data centers 102 (e.g., between backend servers and other components) within cloud 100 to return a response 108 to UE 104. The turnaround time specified for various application procedures is typically relatively short (e.g., one second or less). Also, since an application procedure (also referred to as a “message sequence chart” or “MSC”) only describes a single execution scenario, a cloud-hosted application can have multiple application procedures, each associated with potentially different latency performance requirements.

However, while component processing time tends to be a constant (i.e., independent of its location) for a particular application procedure, the communication time between data centers can vary based on the locations of the application components within the cloud computing platform. Further, while the locations of some application components may be fixed or known beforehand, other application components can be placed freely within the cloud computing platform. In one embodiment, when an application component's location is fixed or known beforehand, then it may be associated with a node, v in V, and the node, v, may represent the application component in mathematical descriptions of latency performance requirements. For example, a cellular base station tower, which typically has a fixed physical location, may be associated with a node. In contrast, there is oftentimes more freedom in determining where to locate backend processing and signaling application components. In such cases, a variable, x in X, may represent an application component whose location is to be decided, with X denoting the set of all such variable application components.

Therefore, application-level latency performance requirements may be represented as a collective latency, which specifies a collection of additive latencies. An additive latency corresponds to the communication latency of an application procedure. The total communication latency for an application procedure is additive in terms of pairwise latency among each pair of communicating application components, weighted by the number of messages exchanged between the pair during the application procedure. As such, application latency may be represented mathematically as follows:

e::=p|a|I
(pairwise latency) p::=(n₁, n₂), where n₁, n₂ in X∪V are a pair of communicating components the locations of which are either known or to be decided.
(additive latency) a::=(r, p)|a+(r, p), where the weight r in R₊ represents the total number of messages exchanged between the pair p.
(collective latency) I::={a₁, . . . , aₙ} is a set of additive latencies.

It can be assumed that an additive expression, a, can have at most one appearance for any given pairwise subexpression. For example, instead of an additive latency . . . +(2, (x, v))+ . . . +(3, (v, x))+ . . . , these pairwise expressions can be combined as . . . +(5, (x, v))+ . . . .

A latency expression, e, on a cloud platform (V,w) can be evaluated for a location assignment, m: X→V, denoted as ∥e∥ₘ.
∥(n₁, n₂)∥ₘ=w(∥n₁∥ₘ, ∥n₂∥ₘ), where ∥n∥ₘ=m(n) if n in X and n if n in V
∥(r, p)∥ₘ=r×∥p∥ₘ, where p::=(n₁, n₂)
∥a+(r, p)∥ₘ=∥a∥ₘ+r×∥p∥ₘ
∥{a₁, . . . , aₙ}∥ₘ=max_{i=1, . . . , n}∥aᵢ∥ₘ

Given location assignments, m, which place application components, X, within data centers, V, ∥e∥ₘ interprets: (a) each pairwise latency as the underlying network delay between the data centers to which the application components are assigned; (b) an additive latency as sum of the pairwise latencies weighted by the number of messages exchanged between the pairs respectively; and (c) a collective latency as the maximum of its element additive latencies.

As such, determining a location assignment for minimal latency can be expressed as finding a location assignment, m: X→V, that minimizes ∥e∥ₘ (i.e., arg min_{m:X→V}∥e∥ₘ), given a cloud platform, (V,w), (variable) application components, X, and a (collective) latency expression, e.

A latency performance requirement, dᵢ, associated with an application procedure having an additive latency, aᵢ, can be described as ∥aᵢ∥ₘ≦dᵢ, which is equivalent to the constraint ∥a^{o}ᵢ∥ₘ≦1 where the additive expression, a^{o}ᵢ, is obtained from aᵢ by dividing all the coefficients by dᵢ. The latency performance constraints can be normalized into the form ∥aᵢ∥ₘ≦1. An application procedure having latency bounds ∥aᵣ∥ₘ≦1, . . . , ∥aₙ∥ₘ≦1 can then be represented as ∥I∥ₘ≦1 with collective latency I={a₁, . . . , aₙ}. Therefore, the problem of whether the application can meet its latency requirements is equivalent to finding a location assignment, m, such that ∥I∥ₘ≦1.

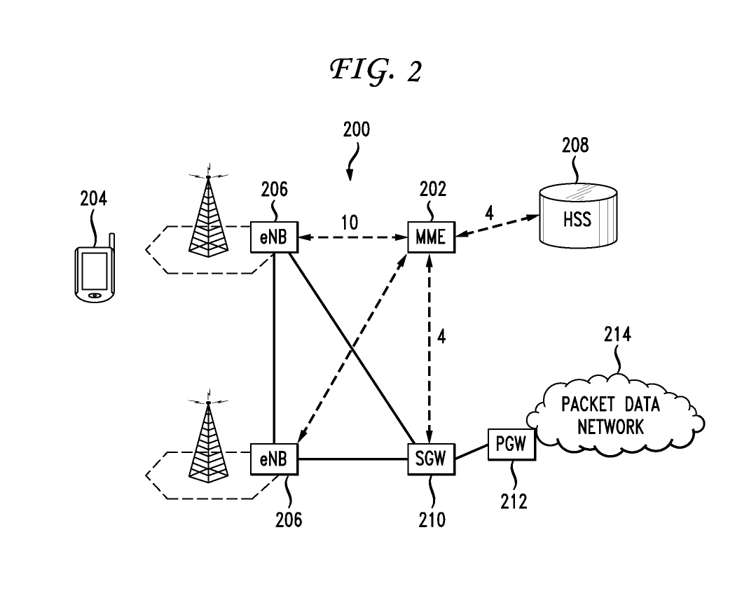

FIG. 2 is a diagram of a telecommunications network in accordance with an embodiment. Network 200 includes one or more application components for implementing various telecommunications applications. For example, network 200 includes Mobility Management Entity (MME) 202, a control plane element for an LTE architecture network. MME 202 provides one or more signaling functions, including: a) registering a mobile user equipment (UE) device 204 (e.g., a mobile phone) to network 200 when UE 204 powers on; b) initiating a handoff between 3GPP base stations (eNBs) 206 as UE 204 moves; and c) paging an idle UE 204 (e.g., for notification of an incoming call, etc.). For example, an attach procedure is triggered when UE 204 is powered on and sends an initial message via wireless link to a nearby eNB 206. The eNB 206 relays the message to MME 202, which authenticates UE 204 using records stored in its corresponding Home Subscriber Server (HSS) 208. MME 202 then establishes data paths between UE 204 and one or more Service Gateways (SGW) 210, PGWs 212 and packet data network 214. In one embodiment (as indicated in FIG. 2), this attach procedure includes ten messages between MME 202 and eNB 206, four messages between MME 202 and HSS 208, and four messages between MME 202 and SGW 210. For various telecommunications protocols, a latency performance requirement for an attach procedure can be as low as two seconds, or less. As such, the latency performance requirement for the given example can be specified as an additive latency, represented by the expression:

(10,(MME,eNB))+(4,(MME,HSS))+(4,(MME,SGW))≦2

Other procedures may have similar additive latency requirements. For example, a half-second latency performance requirement for a handoff procedure from a source eNB to a target eNB of a same MME may be represented by the expression:

(2,(MME,target eNB))+(2,(MME,SGW))+(6,(source eNB,target eNB))+(1,(source eNB,SGW))+(1,(target eNB,SGW))≦0.5

To meet such performance requirements, MME 202 may include a chassis containing tens of hardware blades interconnected via a very fast mesh network. Each blade may have several CPUs, network processors, and special hardware. More blades may be added into the chassis to scale up the number of sessions it can support. For example, each session may hold data, and be responsible for, managing a single UE 204. Application procedures for different sessions may then be executed concurrently in MME 202 and since all sessions are hosted in a same chassis, the latency performance for each session may be predictable.

However, since eNBs are geographically distributed in practice (e.g., to constitute a wireless coverage area), it is advantageous to have distributed MME components (and other application components) placed close to the eNBs to which associated UEs are regularly attached. For example, while a centralized MME can include a set of blades, a distributed MME can include a set of virtual blades. In one embodiment, a virtual blade can host many UE sessions, and the latency performance requirements for these sessions may all constrain the placement of a virtual blade. Therefore, a virtual blade may be placed such that the latency requirements for its corresponding application procedures are satisfied. In addition, when a distributed MME scales up or down at run time to reflect different levels of demand, a virtual blade may be created or existing ones merged.

As disclosed herein, an automatic, low latency location assignment algorithm can be utilized to determine either an optimal placement of a virtual blade, or a near-optimal placement of a virtual blade (e.g., for instances requiring a faster decision time). The various examples below describe steps for determining location assignments for the distributed deployment of MME virtual blades in a cloud computing platform, however, one skilled in the art will appreciate the general utility of the location assignment algorithm for determining a location assignment for any application component, including eNBs, S-GWs and the like.

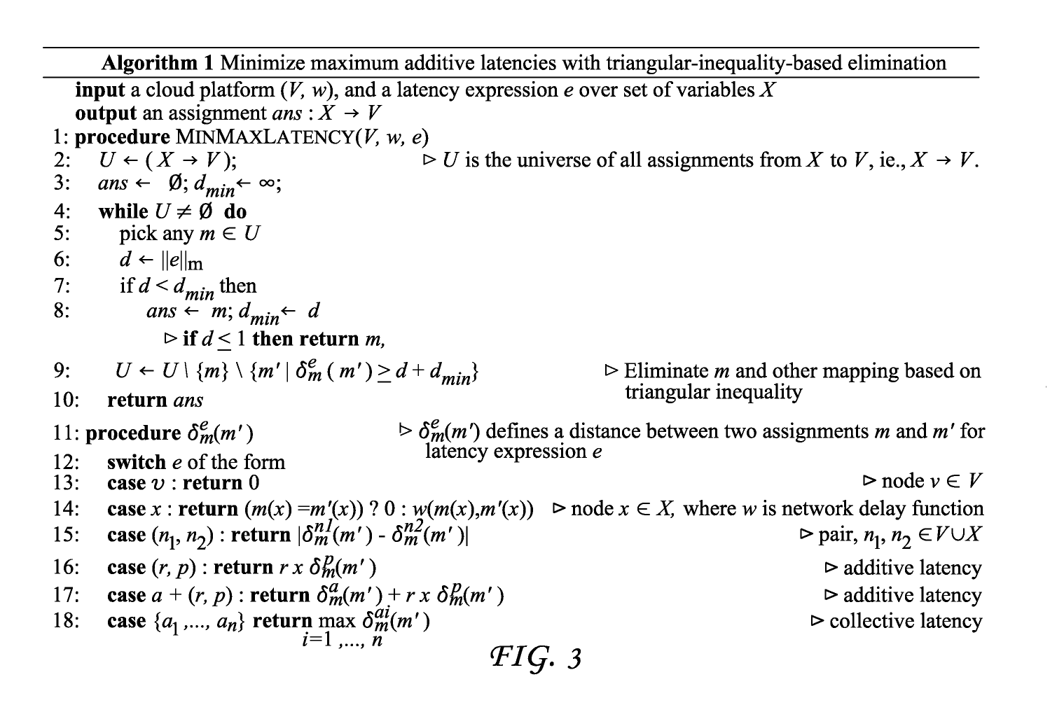

FIG. 3 illustrates a location assignment algorithm for determining an optimal placement of an application component within a cloud computing platform in accordance with an embodiment. In an exemplary embodiment, the location assignment algorithm determines a location assignment for minimal latency based on triangular inequality of network delay properties to eliminate unlikely location assignments. However, the location assignment algorithm can determine a location assignment for an application component even if no triangular inequality based elimination assumptions are used.

At line 2, a set of potential location assignments is determined for a universe, U (e.g., a set of mappings from X to V in a cloud computing platform). In one embodiment, an application component can be placed at any data center in V. Further, each application component may have its own distinct domain (i.e., a set of allowed data centers where the component may be placed).

At line 5, a mapping of potential location assignments, m, is iteratively determined from the set of potential location assignments. After the mapping is determined, additional criteria may be considered. For example, additional criteria may take into account whether an application component should be placed in a data center different from an associated backup application component, or whether a capacity limit of a data center has been exceeded. These additional criteria may therefore narrow the set of potential location assignments.

At lines 6 through 8, the algorithm determines a minimal value for latency performance, e, within the cloud platform (V, w). For example, the algorithm may terminate when a latency performance threshold is met, such as whenever it encounters a mapping value that is less than or equal to 1. After the mapping, m, has been considered, at line 9 the algorithm removes not only m from the set of potential location assignments, but also those mappings whose distance from m is more than a threshold d+dₘᵢₙ based on triangular inequality assumptions.

As such, when a potential location assignment m is considered, those assignments, m₀, whose distance from m (i.e., δ^{e}ₘ(m₀)) is larger than d+dₘᵢₙ (with ∥e∥ₘ=d) must have a value no smaller than dₘᵢₙ—the smallest value observed so far. Therefore, these potential location assignments can be eliminated. In general, the location assignment algorithm iterates for |V|^{(x)} steps, which is exponential based on the size of the input (i.e., the number of application components to be placed).

As mentioned previously, telecommunications network UEs are managed independently. Therefore, from the point of view of latency performance requirements, a collective latency can be further partitioned into smaller subsets in which all variables (i.e., application components to be placed) are either directly or indirectly related.

Given a collective latency e={a₁, a₂, . . . , aₙ}, an equivalence relation, R_{(e,x)}⊂X×X can be defined as follows,
(x, y)εR_{(e,x)} if x and y appear in the same additive latency expression aᵢεe for some 1≦i≦n.
(reflexivity) (x, x)εR_{(e,x)} for all xεX
(symmetry) (x, y)εR_{(e,x)} if (y, x)εR_{(e,x)}
(transitivity) (x, z)εR_{(e,x)} if (x, y)εR_{(e,x)} and (y, z)εR_{(e,x)}

As R_{(e,x)} is an equivalence relation, it divides X into many partitions X/R_{(e,x)}={Y₁, Y₂, . . . , Yₖ} with Yᵢ⊂X, Yᵢ∩Yⱼ=Ø; for 1≦i, j≦k and i≠j, and X=∪Yᵢ.

For any subset of variables, Y⊂X, the restriction of the expression e to the set Y, denoted e|Y is obtained by:
a) removing from e any subexpressions of the form (r, (n₁, n₂)) where {n₁, n₂} is not a subset of Y∪V; and
b) removing resulting additive expressions which contain no variable.

As such, any additive expression a in e|Y contains at least one variable. If an additive expression a₀ in e has no variable, it will be excluded from e|Y. Additive expressions with no variables can be evaluated straightforwardly on a cloud platform (V, w), and they do not affect the assignment of variables. These additive expressions with no variables may be evaluated on a cloud platform independent of variable assignments. If such an evaluation shows that the latency constraints cannot be met, the variable assignments will not change the results (that the constraints cannot be met).

Given a collective latency e={a₁, a₂, . . . , aₙ} such that each aᵢ (for 1≦i≦n) contains at least a variable, {e|Y|YεX/R_{(e,x)}} is a partition of e. In the distributed MME example, even though a plurality of application components (virtual blades) can be placed simultaneously, these components are inherently independent in that UEs act independently of each other (e.g., powering on, moving from place to place). As such, the placement problem can be partitioned into smaller sub-problems (i.e., independent subsets having a small number of variables).

The example above determines location assignments for a plurality (e.g., hundreds or thousands) of MME virtual blades. All other application components (e.g., HSS, SOW, eNBs, etc.) are manually assigned to some data centers beforehand. There is only one variable application component in every application procedure and in every corresponding additive latency expression, since the variable application components do not communicate directly during an application procedure. As a result, all application components are independent and each partition of collective latency expression (in the form of e|Y) contains only one variable.

In instances where virtual blades and SGWs are placed simultaneously, the restriction e|Y may have two variables when each virtual blade has its own SGW, tens of variables when virtual blades share SGWs in a many-to-one ratio (i.e., a shared SGW variable relates all the connected virtual blades), or hundreds or thousands of variables when different SGWs and various virtual blades are all transitively related. In the latter two cases, a near-optimal variation of the location assignment algorithm can be employed in certain scenarios to determine a location assignment for an application component (e.g., for a normalized latency expression e to find the assignment m such that ∥e∥ₘ≦1).

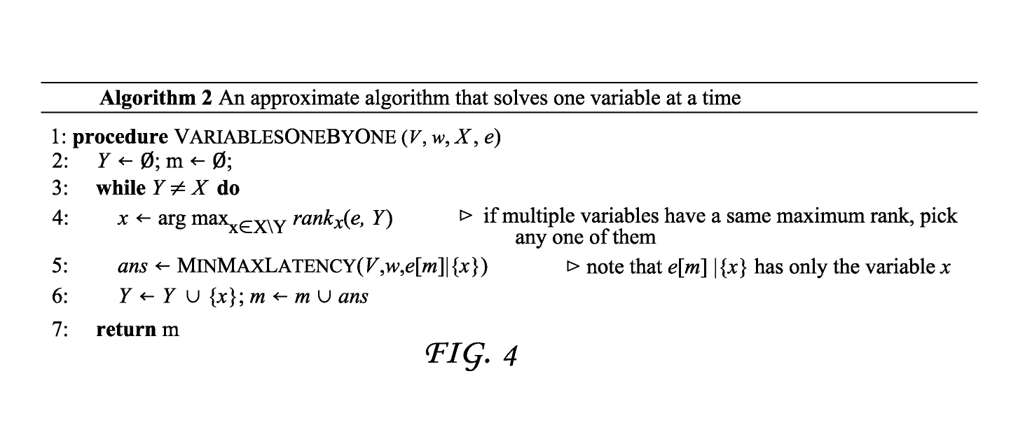

FIG. 4 illustrates a location assignment algorithm for determining a near-optimal placement of an application component in a cloud computing platform in accordance with an embodiment. In scenarios having a large number of variable application components (e.g., virtual blades), a variation of the location assignment algorithm can be utilized to determine a near-optimal placement solution. While the location assignment algorithm determines the location assignments for all application components simultaneously, the near-optimal variation of the location assignment algorithm considers the location assignments of application components individually (i.e., one at a time). For example, a location assignment for a first application component is determined, and then the method moves on to determine a location assignment for a next application component.

In one embodiment, at line 4, a ranking order of variable application components is determined that establishes an order for determining location assignments. For example, a subset of the variables can be denoted as Y⊂X, where Y is a set of variables for which a location assignment has already been determined. A ranking for an application component x in X\Y (an unassigned application component) with respect to an expression, e, denoted rankₓ(e,Y) can therefore be determined as follows:

$${rank}_{x} ( ( {n}_{1} , {n}_{2} ) , Y ) = \{ \begin{matrix}1 , & \begin{matrix}if \{ {n}_{1} , {n}_{2} \} ⋂ \{ x \} \neq θ , \\ and \{ {n}_{1} , {n}_{2} \} ⊆ \{ x \} ⋃ Y ⋃ V\end{matrix} \\ 0 , & otherwise\end{matrix} \\ {rank}_{x} ( ( r , p ) , Y ) = r \times {rank}_{x} ( p , Y ) \\ {rank}_{x} ( a + ( r , p ) , Y ) = {rank}_{x} ( a , Y ) + r \times {rank}_{x} ( p , Y ) \\ {rank}_{x} ( \{ {a}_{1} , … , {a}_{n} \} , Y ) = {max}_{i = 1 , … , n} {rank}_{x} ( {a}_{i} , Y )$$

Essentially, the rank function rankₓ(e, Y) considers the coefficients of pairs involving the variable x and variables that have already been solved or constants (i.e., data centers) and multiplies, adds, and takes the max in a manner respecting the semantics of the expressions. Therefore, the rank function gives higher ranking to pairs consisting of an unsolved variable and a known node (i.e., either a solved variable or a constant).

At line 5, a location assignment is determined for an application component based on previously determined location assignments. For example, this can be done by considering only the subpart of the expression that consists of pairs that only mention constants (e.g., fixed application components such as eNBs), already placed application components, or the application components currently being placed. As such, for any partial assignment m: X→V (i.e., m is a partial map from X to V that is defined on some subset of X), e[m] denotes the substitution of e by m, (i.e., replace in the expression e every variable x in the domain of m by m(e)). For each application component, x, selected from the ranking order determined at line 4, the application location algorithm then determines a location assignment based on the restriction of the expression e[m] to the set {x}, i.e., e[m]I{x}, in order to get an assignment of x.

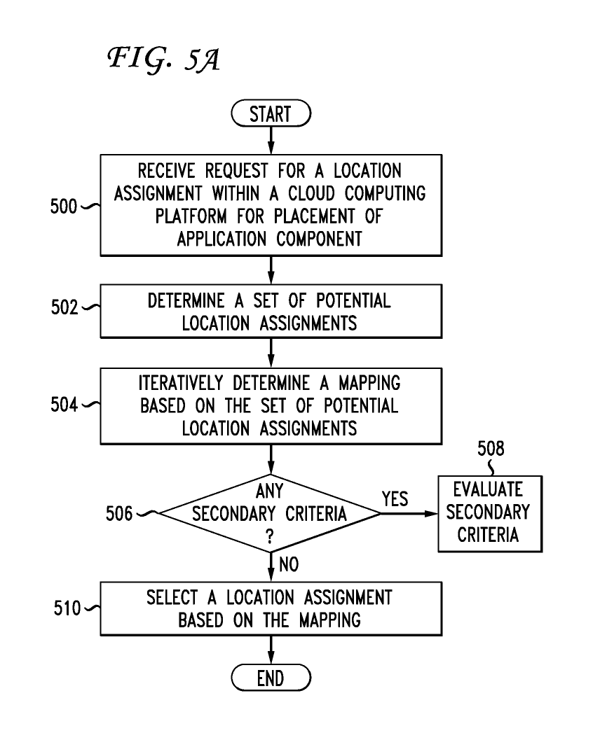

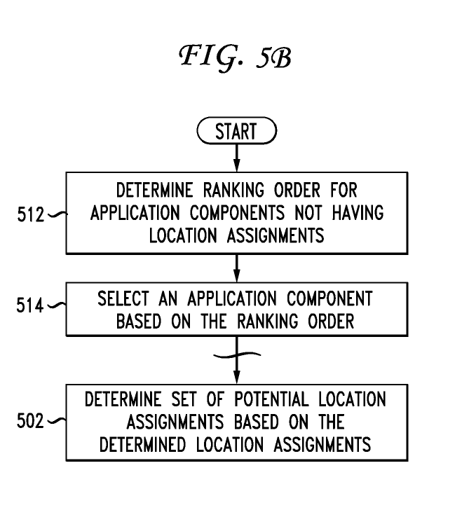

FIG. 5A is a flowchart of a process for determining a location assignment for an application component in accordance with an embodiment. In operation, at 500, a request is received via an input/output device for a location assignment within a cloud computing platform for a placement of an application component. At 502, a set of potential location assignments is determined for the application component within the cloud computing platform. For example, the set of potential location assignments can be determined based on an application procedure or a user equipment device associated with the application component. At 504, a mapping is iteratively determining based on the set of potential location assignments and a latency performance threshold. For example, the mapping can be iteratively determined based on a triangular inequality of network delay property, wherein (using the distributed MME virtual blade example above) the set of potential locations within the cloud computing platform comprise cloud-hosted data centers. Further, the latency performance threshold may be based on one of a 2G, 3G, or LTE telecommunications protocol performance requirement.

At 506, the set of potential location assignments may be determined for the application component based on additional secondary criteria. For example, secondary criteria may include a location assignment for an associated backup application component. In another example, secondary criteria may include an application component capacity threshold for a potential location (e.g., a data center may have a maximum capacity threshold for hosting application components). If secondary criteria are available, the criteria may be evaluated in light of the mapping at 508. At 510, a location assignment is selected for the application component based on the mapping and sent, for example, via the input/output device to a location assignment controller for placing the application component.

FIG. 5B is a flowchart of a process for determining a location assignment for an application component in accordance with another embodiment. As described above, the cloud computing platform may comprise a plurality of application components. Further, one or more location assignments associated with one or more of the plurality of application components may be previously determined. For example, constants (e.g., fixed-location application components such as eNBs), already placed variable-location application components, or the variable-location application components currently being placed all may have determined location assignments. As such, in one embodiment at 512, a ranking order for the plurality of application components not having location assignments is determined based on the one or more determined location assignments. For example, the ranking order may be determined based on the ranking function described above and in FIG. 4. When the ranking order is determined, at 514, an application component may be selected based on the ranking order to determine a new location assignment. The method may then continue on, starting at 502 of FIG. 5A, where the set of potential location assignments is determined for the selected application component based on the one or more determined location assignments.

In various embodiments, the method steps described herein, including the method steps described in FIGS. 5A & 5B, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 5A & 5B. Certain steps of the methods described herein, including one or more of the steps of FIGS. 5A & 5B, may be performed by a server or by another processor in a network-based cloud-computing system. Certain steps of the methods described herein, including one or more of the steps of FIGS. 5A & 5B, may be performed by a client computer in a network-based cloud computing system. The steps of the methods described herein, including one or more of the steps of FIGS. 5A & 5B, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 5A & 5B, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

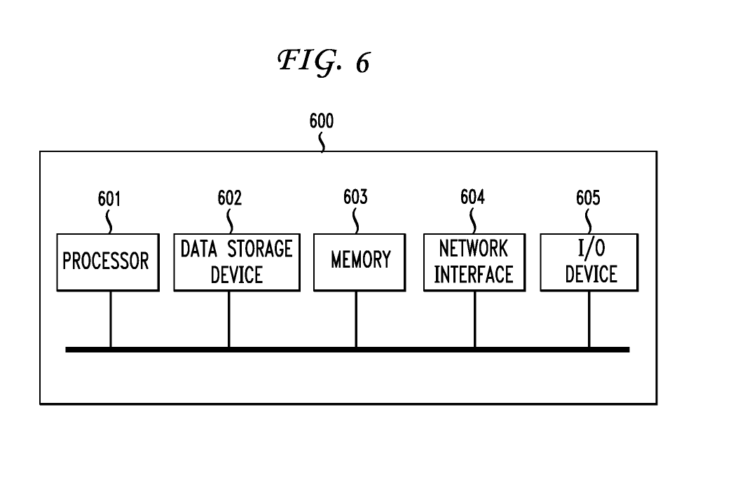

A high-level block diagram of an exemplary computer that may be used to implement systems, apparatus and methods described herein is illustrated in FIG. 6. Computer 600 includes a processor 601 operatively coupled to a data storage device 602 and a memory 603. Processor 601 controls the overall operation of computer 600 by executing computer program instructions that define such operations. The computer program instructions may be stored in data storage device 602, or other computer readable medium, and loaded into memory 603 when execution of the computer program instructions is desired. Thus, the method steps of FIGS. 5A & 5B can be defined by the computer program instructions stored in memory 603 and/or data storage device 602 and controlled by the processor 601 executing the computer program instructions. For example, the computer program instructions can be implemented as computer executable code programmed by one skilled in the art to perform an algorithm defined by the method steps of FIGS. 5A & 5B. Accordingly, by executing the computer program instructions, the processor 601 executes an algorithm defined by the method steps of FIGS. 5A & 5B. Computer 600 also includes one or more network interfaces 604 for communicating with other devices via a network. Computer 600 also includes one or more input/output devices 605 that enable user interaction with computer 600 (e.g., display, keyboard, mouse, speakers, buttons, etc.).

Processor 601 may include both general and special purpose microprocessors, and may be the sole processor or one of multiple processors of computer 600. Processor 601 may include one or more central processing units (CPUs), for example. Processor 601, data storage device 602, and/or memory 603 may include, be supplemented by, or incorporated in, one or more application-specific integrated circuits (ASICs) and/or one or more field programmable gate arrays (FPGAs).

Data storage device 602 and memory 603 each include a tangible non-transitory computer readable storage medium. Data storage device 602, and memory 603, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 605 may include peripherals, such as a printer, scanner, display screen, etc. For example, input/output devices 605 may include a display device such as a cathode ray tube (CRT) or liquid crystal display (LCD) monitor for displaying information to the user, a keyboard, and a pointing device such as a mouse or a trackball by which the user can provide input to computer 600.

Any or all of the systems and apparatus discussed herein may be implemented using a computer such as computer 600.

One skilled in the art will recognize that an implementation of an actual computer or computer system may have other structures and may contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of this disclosure. Those skilled in the art could implement various other feature combinations without departing from the scope and spirit of this disclosure.

We claim:

1. An apparatus, comprising:
an input/output device configured to receive a location assignment request and send a location assignment of an application component within a cloud computing platform;
a data storage device; and
a processor communicatively coupled to the data storage device, the processor in cooperation with the data storage device configured to:
determine a set of potential location assignments for an application component within a cloud computing platform;
iteratively determine a mapping based on the set of potential location assignments and a latency performance threshold; and
select a location assignment for the application component based on the mapping.

2. The apparatus of claim 1, wherein the processor in cooperation with the data storage device is further configured to determine the set of potential location assignments based on at least one of an application procedure and a user equipment device associated with the application component.

3. The apparatus of claim 1, wherein the processor in cooperation with the data storage device is further configured to iteratively determine the mapping based on a triangular inequality of network delay property.

4. The apparatus of claim 1, wherein the set of potential locations within the cloud computing platform comprise cloud-hosted data centers.

5. The apparatus of claim 1, wherein the processor in cooperation with the data storage device is further configured to determine the set of potential location assignments for the application component based on secondary criteria.

6. The apparatus of claim 5, wherein the secondary criteria includes at least one of a location assignment for an associated backup application component and an application component capacity threshold for a potential location.

7. The apparatus of claim 1, wherein the cloud computing platform comprises a plurality of application components and one or more determined location assignments are associated with one or more of the plurality of application components, and wherein the processor in cooperation with the data storage device is further configured to:
determine a ranking order for the plurality of application components based on the one or more determined location assignments.

8. The apparatus of claim 7, wherein the processor in cooperation with the data storage device is further configured to:
select an application component based on the ranking order; and
determine the set of potential location assignments for the application component based on the one or more determined location assignments.

9. A non-transitory computer-readable medium having program instructions stored thereon, the instructions capable of execution by a processor and comprising:
receiving a request for a location assignment of an application component within a cloud computing platform;
determining a set of potential location assignments for an application component within a cloud computing platform;
iteratively determining a mapping based on the set of potential location assignments and a latency performance threshold; and
selecting a location assignment for the application component based on the mapping.

10. The non-transitory computer-readable medium of claim 9, wherein the set of potential location assignments is determined based on at least one of an application procedure and a user equipment device associated with the application component.

11. The non-transitory computer-readable medium of claim 9, wherein the mapping is iteratively determined based on a triangular inequality of network delay property.

12. The non-transitory computer-readable medium of claim 9, wherein the set of potential locations within the cloud computing platform comprise cloud-hosted data centers.

13. The non-transitory computer-readable medium of claim 9, further comprising instructions for determining the set of potential location assignments for the application component based on secondary criteria.

14. The non-transitory computer-readable medium of claim 13, wherein the secondary criteria includes at least one of a location assignment for an associated backup application component and an application component capacity threshold for a potential location.

15. The non-transitory computer-readable medium of claim 9, wherein the cloud computing platform comprises a plurality of application components and one or more determined location assignments are associated with one or more of the plurality of application components, further comprising instructions for:
determining a ranking order for the plurality of application components based on the one or more determined location assignments.

16. The non-transitory computer-readable medium of claim 15, further comprising instructions for:
selecting an application component based on the ranking order; and
determining the set of potential location assignments for the application component based on the one or more determined location assignments.

17. A method comprising:
at a processor communicatively coupled to a data storage device, receiving a request for a location assignment of an application component within a cloud computing platform;
determining, by the processor in cooperation with the data storage device, a set of potential location assignments for the application component within the cloud computing platform;
iteratively determining, by the processor in cooperation with the data storage device, a mapping based on the set of potential location assignments and a latency performance threshold; and
selecting, by the processor in cooperation with the data storage device, a location assignment for the application component based on the mapping.

18. The method of claim 17, further comprising determining, by the processor in cooperation with the data storage device, the set of potential location assignments for the application component based on secondary criteria.

19. The method of claim 17, wherein the cloud computing platform comprises a plurality of application components and one or more determined location assignments are associated with one or more of the plurality of application components, the method further comprising:
determining, by the processor in cooperation with the data storage device, a ranking order for the plurality of application components based on the one or more determined location assignments.

20. The method of claim 19, further comprising:
selecting, by the processor in cooperation with the data storage device, an application component based on the ranking order; and
determining, by the processor in cooperation with the data storage device, the set of potential location assignments for the application component based on the one or more determined location assignments.
